(19) United States
(12) Patent Application Publication
(10) Pub. No.: US 2016/0338542 A1
(43) Pub. Date: Nov. 24, 2016

(54) FOOD SKEWER AND FOOD DIP COATING METHODS AND APPARATUSES

(71) Applicant: Franke Technology and Trademark Ltd., Hergiswil (CH)

(72) Inventor: Blago Lakic, Vancouver (CA)

(73) Assignee: Franke Technology and Trademark Ltd., Hergiswil (CH)

(21) Appl. No.: 15/133,138

(22) Filed: Apr. 19, 2016

Related U.S. Application Data
(60) Provisional application No. 62/165,434, filed on May 22, 2015.

(51) Int. Cl. A47J 43/18

(52) U.S. Cl. CPC A47J 43/18

(57) ABSTRACT

A skewer for securing a food item and insertion into an aperture of a skewer holder, the skewer comprising a retention portion at one end of the skewer configured to receive and secure the food item; a grip portion at an opposite end of the skewer; and an engagement portion. The engagement portion has a compressed configuration when in contact with an inner surface of the aperture in which the longest cross-sectional width across the engagement portion is less than a shortest cross-sectional width of the aperture. The engagement portion also has an expanded configuration when not in contact with the inner surface in which the longest cross-sectional width across the engagement portion is greater than the shortest cross-sectional width of the aperture.

### CROSS-REFERENCE TO RELATED APPLICATION

This application claims the benefit under 35 U.S.C. §119 of U.S. Application No. 62/165434 filed 22 May 2015 and entitled FOOD SKEWER AND FOOD DIP COATING METHODS AND APPARATUSES, which is hereby incorporated herein by reference for all purposes.

### TECHNICAL FIELD

The technology disclosed herein relates to methods and systems for securing food items.

### BACKGROUND

Skewers are typically elongated rods that may be used to hold food items that are to be barbecued, roasted, or otherwise cooked. Skewers may be made of different types of materials, including metal, bamboo, wood, plastic, and/or the like.

Skewers may also be used to hold food items for display purposes. For instance, pieces of fruits held by skewers may be organized into different decorative arrangements, such as floral arrangements, bouquets, and the like.

Food items held on skewers may be coated with different materials, such as dark chocolate, white chocolate, milk chocolate, powdered sugar, and/or the like. To coat the food items on a commercial scale, systems, such as those described in U.S. Patent Application Publication No. 2014/0030399, may be used for performing the coating.

### BRIEF SUMMARY OF THE DISCLOSURE

In various aspects, the invention provides skewers for holding food items and methods and systems for coating food items.

One aspect of the invention provides a skewer for securing a food item and insertion into an aperture of a skewer holder. The skewer comprises a retention portion at one end of the skewer configured to receive and secure the food item, a grip portion at an opposite end of the skewer, and an engagement portion between the retention portion and the grip portion. The engagement portion has a compressed configuration when it is in contact with an inner surface of the aperture, and the longest cross-sectional width across the engagement portion is less than a shortest cross-sectional width of the aperture in the compressed configuration. When the engagement portion is not in contact with the inner surface of the aperture, the engagement portion is in an expanded configuration in which the longest cross-sectional width across the engagement portion is greater than the shortest aperture cross-sectional width.

In some embodiments, the engagement portion comprises a compression aperture and a bridge member connecting the retention portion and the grip portion around the compression aperture. In some embodiments, the bridge member moves into the compression aperture upon contact with the inner surface of the aperture. In some embodiments, the bridge member extends away from a side of the skewer at an angle at or greater than 90°. In some embodiments, the skewer comprises two compression apertures and two bridge members. In further embodiments, the two compression apertures and two bridge members are symmetrical about a longitudinal axis of the skewer. In other embodiments, the engagement portion comprises a plurality of bridge members and a plurality of compression apertures. In further embodiments, the plurality of bridge members and the plurality of compression apertures are symmetrical about a longitudinal axis of the skewer. In some embodiments, the bridge member is integral to the structure of the skewer. In some embodiments, the bridge member is connected to the skewer around a cavity to form the compression aperture.

In some embodiments, the engagement portion comprises an engagement member and a cavity shaped to fit the engagement member, and the engagement member moves into the cavity upon contact with the inner surface of the aperture. In some embodiments, the engagement portion comprises a compressible member. In further embodiments, the compressible member comprises foam.

In some embodiments, the skewer comprises a holding member that is biased against a surface of the skewer holder after the insertion of the skewer into the aperture. In some embodiments, the holding member comprises a ring-shaped protrusion.

In some embodiments, the retention portion of the skewer terminates in a beveled tip. In some embodiments, the skewer is symmetrical about its longitudinal axis. In some embodiments, the skewer is part of a system for coating the food items.

Another aspect of the invention provides apparatuses for coating a plurality of food items and methods for coating a plurality of food items.

In addition to the exemplary aspects and embodiments described above, further aspects and embodiments will become apparent by reference to the drawings and by study of the following detailed description.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A is a perspective view of a skewer according to an example embodiment.

FIG. 1B is a side view of the skewer of FIG. 1A without the secured food item.

FIG. 1C is a front view of the skewer of FIG. 1B.

FIG. 1D is an enlarged front view of the engagement portion of the skewer of FIG. 1B.

FIG. 2A is a perspective cross-sectional view of the skewers before insertion into a skewer holder according to an example embodiment.

FIG. 2B is a front cross-sectional view of the skewers before insertion into a skewer holder as illustrated in FIG. 2A.

FIG. 2C is an enlarged front cross-sectional view of the skewers before insertion into a skewer holder as illustrated in FIG. 2A.

FIG. 3A is an enlarged front cross-sectional view of a skewer before engagement portion is inserted into an aperture of the skewer holder according to an example embodiment.

FIG. 3B is an enlarged front cross-sectional view of a skewer while the engagement portion is within an aperture of the skewer holder according to an example embodiment.

FIG. 3C is an enlarged front cross-sectional view of a skewer after the engagement portion has exited an aperture of the skewer holder according to an example embodiment.

FIG. 4A is a perspective cross-sectional view of the skewers after insertion into apertures of a skewer holder according to an example embodiment.

FIG. 4B is a front cross-sectional view of the skewers after insertion into apertures of a skewer holder as illustrated in FIG. 4A.

FIG. 4C is an enlarged front cross-sectional view of the skewers after insertion into apertures of a skewer holder as illustrated in FIG. 4A.

### DESCRIPTION

Throughout the following description specific details are set forth in order to provide a more thorough understanding to persons skilled in the art. However, well known elements may not have been shown or described in detail to avoid unnecessarily obscuring the disclosure. The following description of examples of the technology is not intended to be exhaustive or to limit the system to the precise forms of any example embodiment. Accordingly, the description and drawings are to be regarded in an illustrative, rather than a restrictive, sense.

One aspect of the invention provides a skewer for securing a food item and insertion into an aperture of a skewer holder. The skewer comprises a retention portion at one end of the skewer configured to receive and secure the food item, a grip portion at an opposite end of the skewer, and an engagement portion. The engagement portion has a compressed configuration when it is in contact with an inner surface of the aperture. In the compressed configuration, the longest cross-sectional width across the engagement portion is less than a shortest cross-sectional width of the aperture. When the engagement portion is not in contact with the inner surface of the aperture, the engagement portion is in an expanded configuration in which the longest cross-sectional width across the engagement portion is greater than the shortest cross-sectional width.

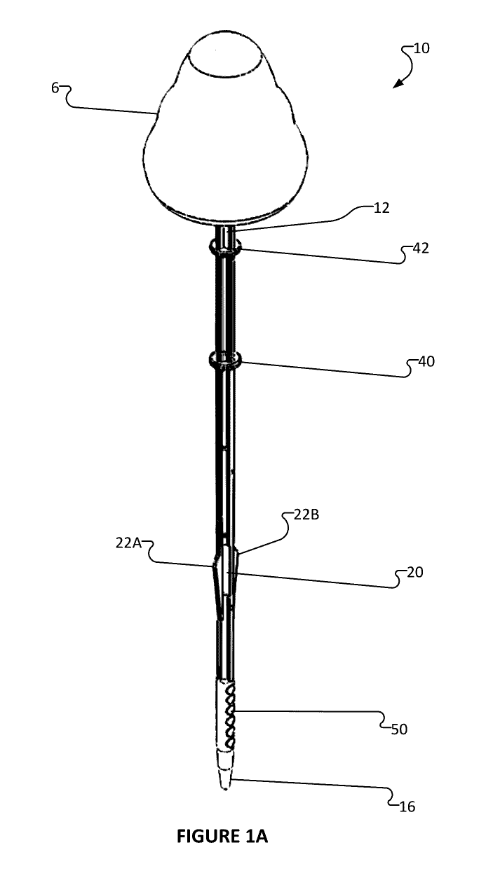

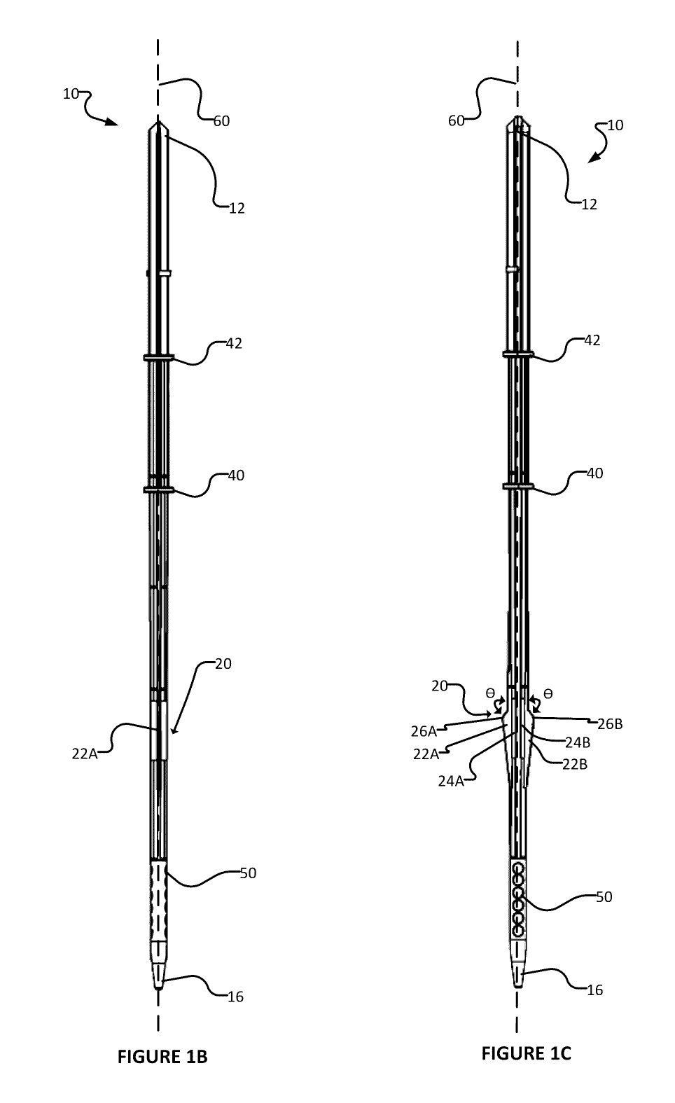

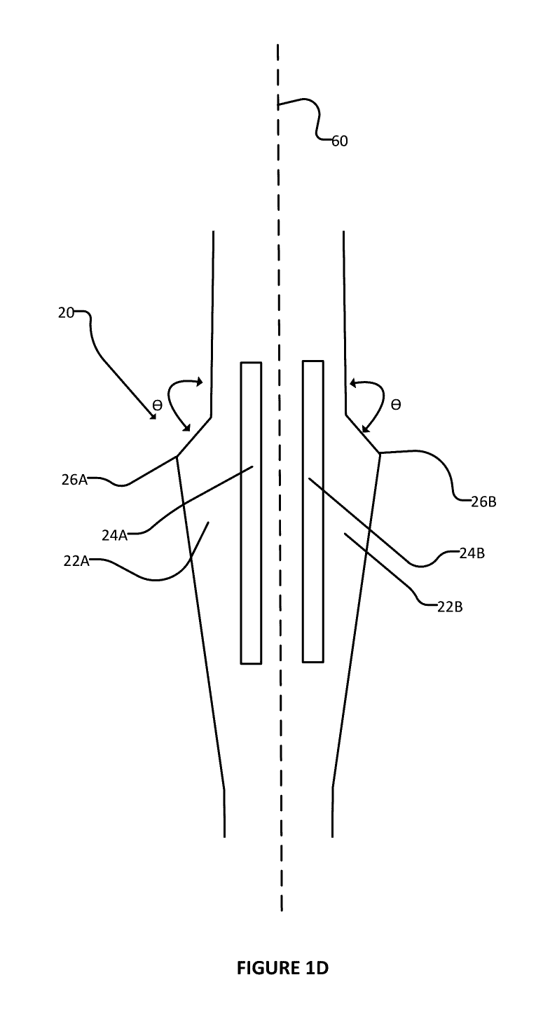

FIGS. 1A, 1B, and 1C illustrate a skewer 10 according to an example embodiment. In this embodiment, skewer 10 comprises an elongated rod that may be made of metal, plastic, bamboo, wood, and/or the like. In the illustrated embodiment, skewer 10 comprises a retention portion 12 for securing food items 6 at one end and a grip portion 16 at the other end. In some embodiments, skewer 10 comprises recesses 50 near the grip portion 16. Recesses 50 may provide users with greater grip of skewer 10 by making grip portion 16 less slippery. Recesses 50 may be used to prevent skewer 10 from slipping out of a decorative arrangement base. Skewers 10 engages aperture 8 removably. In some embodiments, frictional engagement of a portion of skewer 10 with aperture 8 holds skewer 10 in place within aperture 8.

In the illustrated embodiment, retention portion 12 and grip portion 16 are connected by the remaining elongated structure of skewer 10 and an engagement portion 20. In this embodiment, engagement portion 20 is between retention portion 12 and grip portion 16. In some embodiments, engagement portion 20 may be located closer to retention portion 12 when compared to its distance to grip portion 16. In some embodiments, engagement portion 20 may be located closer to grip portion 16 when compared to its distance to retention portion 12. Engagement portion 20 has a compressed configuration when it is in contact with an inner surface of aperture 8, and the longest cross-sectional width across engagement portion 20 is less than a shortest cross-sectional width of aperture 8 in the compressed configuration. When engagement portion 20 is not in contact with the inner surface of aperture 8, engagement portion 20 returns to an expanded configuration in which the longest cross-sectional width across engagement portion 20 is greater than the shortest cross-sectional width of aperture 8.

In the embodiment illustrated in FIGS. 1A, 1B, 1C, and 1D, engagement portion 20 comprises a compression aperture 24 and a bridge member 22 that connects the retention portion 12 and grip portion 16 around the compression aperture 24. In one embodiment, bridge member 22 is integral to the body of skewer 10, but this is not necessary. The illustrated embodiment shows two compression apertures (24A and 24B) and two bridge members 22 (22A and 22B) around the two compression apertures 24A and 24B, and they are arranged symmetrically about longitudinal axis 60 of skewer 10. In other embodiments, engagement portion 20 comprises one bridge member 22 and one compression aperture 24. In further embodiments, engagement portion 20 may comprise a plurality of bridge members 22 and a plurality of compression apertures 24, and they may be arranged symmetrically about longitudinal axis 60 of skewer 10. In some embodiments, bridge member 22 may be a separate component operatively connected to skewer 10 around a cavity to form compression aperture 24. In some embodiments, engagement portion 20 may comprise a combination of bridge member 22 and compression aperture 24 having different shapes and/or configurations.

In the illustrated embodiment, bridge member 22 (22A and 22B) extends away from a side of skewer 10 at an angle θ until an apex 26 (26A and 26B). Engagement portion 20 has the longest cross-sectional width across apexes 26A and 26B. Bridge member 22 (22A and 22B) then extends towards the side of skewer 10 from apex 26 (26A and 26B). In this embodiment, angle θ is greater than 90°. In other embodiments, angle θ is 90°. In some embodiments, angle θ is less than 90°. In other embodiments, engagement portion 20 may have uniform cross-sectional width across the entire length of engagement portion 20.

In some embodiments, engagement portion 20 comprises an engagement member and a cavity shaped to the fit the engagement member. Upon contact with the inner surface of aperture 8, the engagement member is forced into the cavity by a force exerted by the inner surface of aperture 8 and the longest cross-sectional width of engagement portion 20 is reduced so as to allow skewer 10, including engagement portion 20, to move through aperture 8. In one embodiment, the engagement member is rectangular in shape and the cavity is shaped to fit the rectangular shape. In some embodiments, the engagement member may be an annular protrusion and the cavity is shaped to fit the annular shape.

In some embodiments, engagement portion 20 comprises a resiliently compressible member that reduces in size upon contact with the inner surface of aperture 8. The size reduction of the compressible member leads to the reduction of the longest cross-sectional width of engagement portion 20 so that it can move through aperture 8. In some embodiments, compressible member comprises foam, such as ethafoam® polyethylene, polyether poly urethane, polyester polyurethane, and the like. As may be appreciated by a person skilled in the art in light of the present disclosure, the compressible member may comprise many different shapes and/or configurations, such as annular, rectangular, square, triangular, and the like.

In the embodiment illustrated in FIGS. 1A, 1B, and 1C, the retention portion terminates in a beveled tip to provide skewer 10 with greater ability to penetrate and to secure food items 6. In some embodiments, the cross-sectional area of skewer 10 is shaped to provide for fins, such as a cross shape, Y shape, star shape, and/or the like. Grip portion 16 may also terminate in a tapered or beveled tip. The tapered or beveled tip of grip portion 16 would make it easier to insert skewer 10 into a base (such as a styrofoam base or other bases with apertures arranged to provide for food item arrangements).

Skewer 10 as illustrated in FIGS. 1A, 1B, and 1C may also comprise securing member 42 and holding member 40. In this embodiment, securing member 42 is located near the retention portion 12 of skewer 10 and may help to prevent a food item 6 from travelling too far down skewer 10 after insertion of skewer 10 into the food item 6. The location of securing member 42 may be adjusted depending on the type of food item 6 being secured onto skewer 10. Holding member 40 is located further away from retention portion 12 relative to securing member 42 and may help to prevent skewer 10 from travelling too far down or through aperture 8 in skewer holder 1 after insertion of skewer 10. Holding member 40 may have a cross-sectional width greater than the longest cross-sectional width of aperture 8. In the illustrated embodiment, each of securing member 42 and holding member 40 comprises a ring-shaped flange or protrusion that is integral to the structure of skewer 10, but this is not necessary. In some embodiments, securing member 42 is integral to the structure of skewer 10, and holding member 40 is operatively connected to skewer 10. In some embodiments, holding member 40 is integral to the structure of skewer 10, and securing member 42 is operatively connected to skewer 10. In some embodiments, securing member 42 and holding member 40 may both be separate components operatively connected to skewer 10. In some embodiments, securing member 42 may have greater surface area than holding member 40. In some embodiments, securing member 42 and/or holding member 40 may comprise protrusions that are rectangular, square, and/or the like.

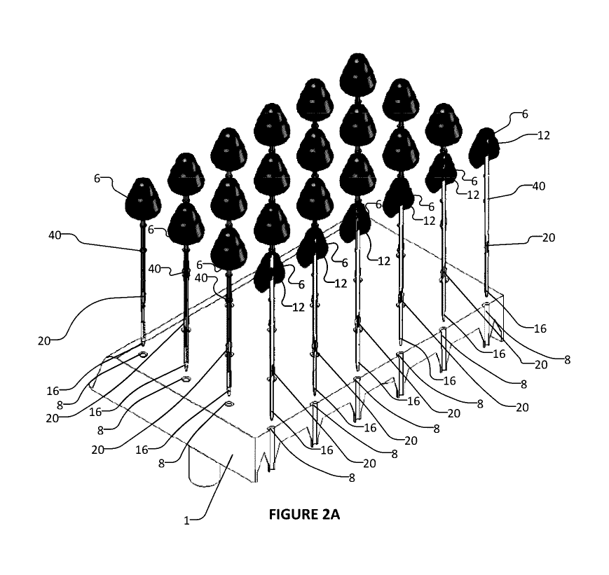

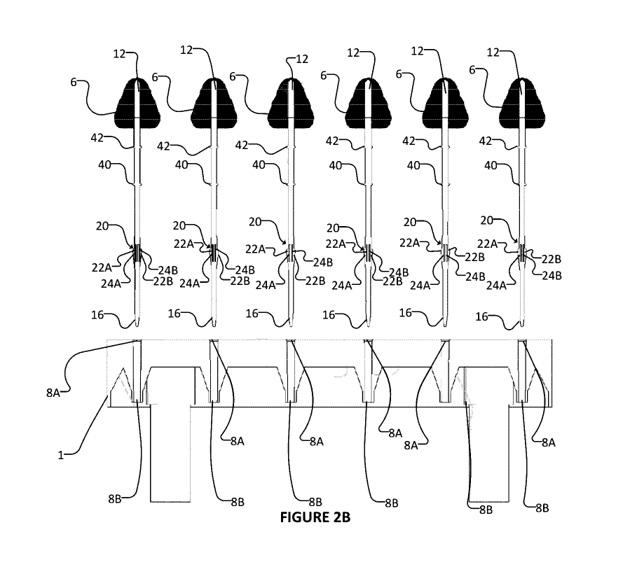

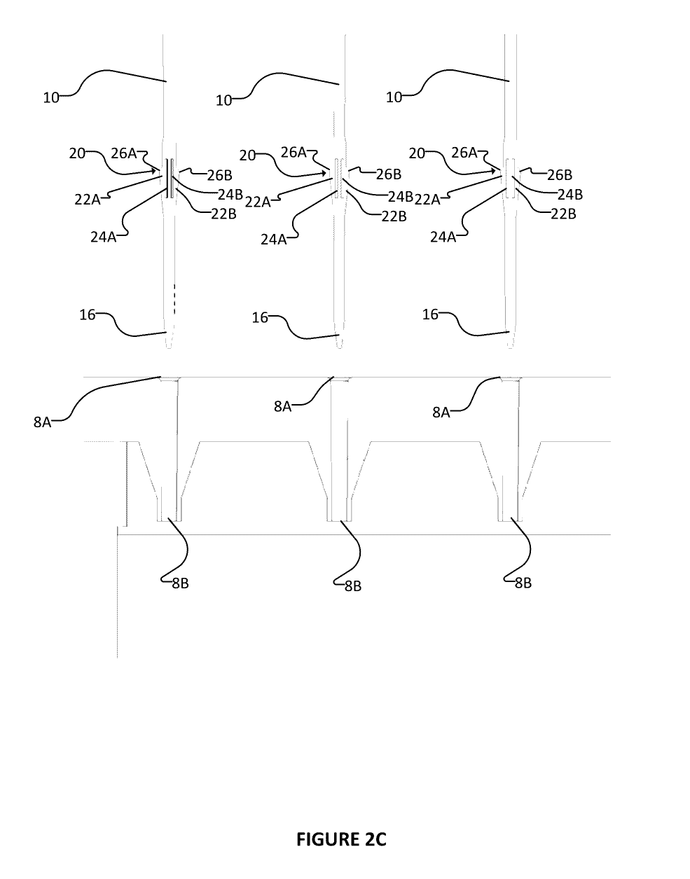

FIGS. 2A, 2B, and 2C illustrate skewer holder 1 and skewers 10 prior to their insertion into skewer holder 1 according to an example embodiment. In the illustrated embodiment, skewer holder 1 comprises a plurality of apertures 8. In this embodiment, skewers 10 similar to those illustrated in FIGS. 1A, 1B, and 1C are used, but other types of skewers may be used. Food items 6 are secured at the retention portion 12 of skewers 10. Skewers 10 are then inserted downwards into apertures 8 with grip portion 16 being the first part inserted. In this embodiment, apertures 8 comprise channels having the same cross-sectional width across the entire length of the channel. In some embodiments, top surface 8A of aperture 8 and bottom surface 8B of aperture 8 have the same cross-sectional width. In some embodiments, apertures 8 may comprise other structures, such as a v-shaped structure with the cross-sectional width narrowing from top surface 8A to the bottom surface 8B of aperture 8. In some embodiments, apertures 8 are integral to the structure of skewer holder 1. In some embodiments, apertures 8 are formed by inserting hollow tubes into skewer holder 1. In some embodiments, apertures 8 are smoothbore. In some embodiments, inner surface of an aperture 8 is textured to allow grip portion 16 of skewer 10 to easily slide into the aperture 8. In some embodiments, inner surface of an aperture 8 is textured to increase frictional engagement with a skewer 10 when the skewer 10 is inserted into the aperture 8.

In some embodiments, apertures 8 of skewer holder 1 may be arranged in rows and columns. In some embodiments, apertures 8 of skewer holder 1 may be arranged in a random fashion. In some embodiments, apertures 8 of skewer holder 1 may be arranged in an N×M array in which the numerical values of N and M may be in the range of 3 to 20 or greater than 20. In some embodiments, the numerical values of N and M are the same. In other embodiments, the numerical values of N and M are different.

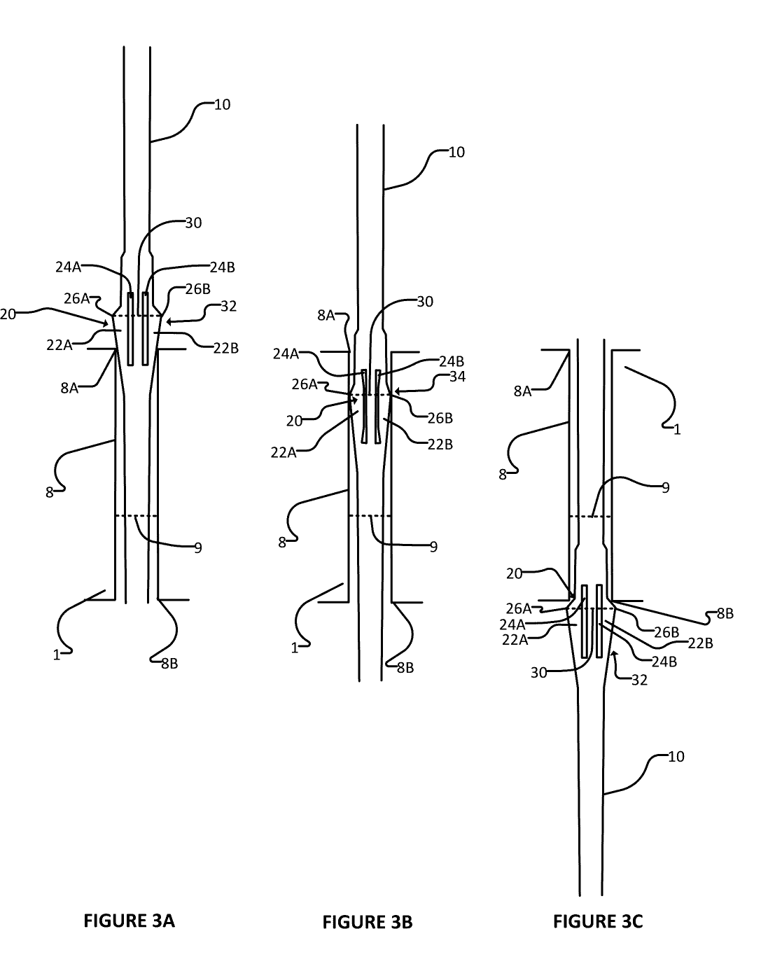

FIGS. 3A, 3B, and 3C illustrate the change of engagement portion 20 of skewer 10 from an expanded configuration to a compressed configuration according to an example embodiment. In the illustrated embodiment, skewers 10 are similar to those described in FIGS. 1A, 1B, and 1C, and engagement portion 20 comprises two compression apertures 24 (24A and 24B) and two bridge members 22 (22A and 22B). Each bridge member 22 (22A and 22B) connects retention portion 12 and grip portion 16 of skewer 10 around compression aperture 24 (24A and 24B).

FIG. 3A illustrates engagement portion 20 in expanded configuration 32 before its insertion into aperture 8 according to an example embodiment. In expanded configuration 32, longest cross-sectional width 30 of engagement portion 20 as measured from apex 26A to apex 26B is greater than the cross-sectional width 9 of aperture 8. As skewer 10 is inserted into aperture 8, bridge member 22 (22A and 22B) comes into contact with the inner surface of aperture 8 at the upper edge 8A. This contact leads to a force being exerted in a direction towards the lateral midpoint of engagement portion 20 from the sides of aperture 8, and engagement portion 20 changes from expanded configuration 32 to compressed configuration 34.

FIG. 3B illustrates engagement portion 20 in compressed configuration 34 when engagement portion 20 is within aperture 8 after insertion of skewer 10 according to an example embodiment. In the compressed configuration 34, bridge member 22 (22A and 22B) moves into compression aperture 24 (24A and 24B) as a result of the lateral force being exerted by the inner surfaces of aperture 8 on bridge member 22 (22A and 22B). The area occupied by compression aperture 24 (24A and 24B) is reduced as bridge member 22 (22A and 22B) is forced towards the lateral midpoint of engagement portion 20. The change in configuration of bridge member 22 and reduction in area occupied by compression aperture 24 lead to a reduction of the cross-sectional width 30 of engagement portion 20 across apexes 26A and 26B. In this embodiment, in compressed configuration 34, the longest cross-sectional width 30 is less than the shortest cross-sectional width of aperture 8 (in this embodiment, cross-sectional width 9). With engagement portion 20 in compressed configuration 34, engagement portion 20 of skewer 10 can fit to be moved through aperture 8 past bottom edge 8B. In some embodiments, engagement portion 20 is retained within aperture 8 and frictionally engages the inner surface of aperture 8. In these embodiments, engagement portion 20 does not pass bottom edge 8B when a skewer 10 is inserted. In these embodiments, the longest cross-sectional width 30 may be the same or about the same as shortest cross-sectional width 9 of aperture 8.

FIG. 3C illustrates engagement portion 20 returning to expanded configuration 32 according to an example embodiment. As skewer 10 moves through aperture 8 and engagement portion 20 moves past bottom edge 8B of aperture 8, the force exerted on engagement portion 20 by the inner surface of aperture 8 is removed. Compression aperture 24(24A and 24B) and bridge member 22 (22A and 22B) are resiliently restored to their normal configurations when engagement portion 20 is in expanded configuration 32. When engagement portion 20 is in expanded configuration 32, longest cross-sectional width 30 across apexes 26A and 26B of engagement portion 20 is again greater than the cross-sectional width 9 of aperture 8.

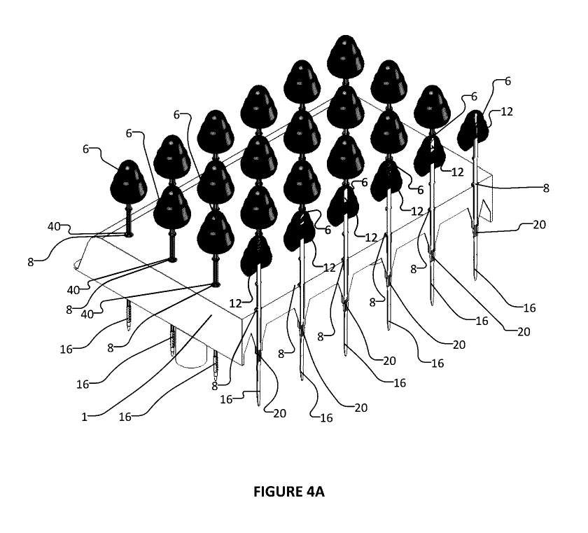

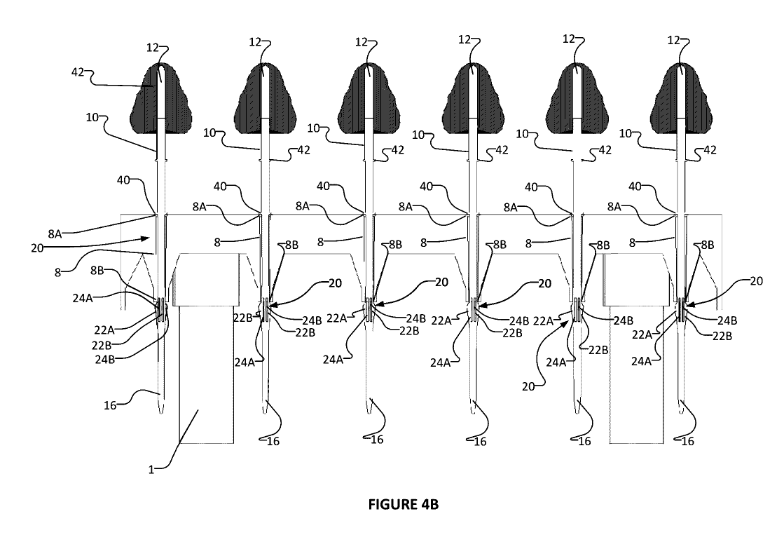

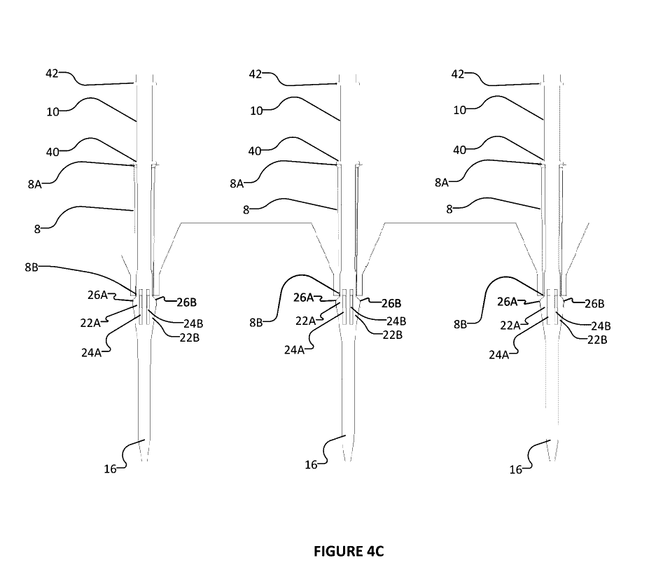

FIGS. 4A, 4B, and 4C illustrate skewers 10 after insertion into apertures of skewer holder 1 according to an example embodiment. In the illustrated embodiment, a plurality of skewers 10 is inserted into respective apertures 8 of skewer holder 1. Engagement portions 20 of the inserted skewers 10 are all in expanded configuration 32. Accordingly, engagement portion 20 blocks skewer 10 from falling out of skewer holder 1 if skewer holder 1 is turned upside down, unless a force is applied to pull a skewer 10 from its respective aperture 8. In some embodiments, the force to pull a skewer 10 out its respective aperture 8 after insertion is at least 150 grams. In some embodiments, the force to pull a skewer 10 out its respective aperture 8 after insertion is in the range of 150 grams to 750 grams.

As more clearly illustrated in FIGS. 4B and 4C, in this embodiment, the length between engagement portion 20 and holding member 40 on skewer 10 is similar to the length of aperture 8 within skewer holder 1. Upon insertion of skewer 10 and engagement portion 20 moving past bottom edge 8B of aperture 8, holding member 40 is in contact with upper edge 8A of aperture 8. Holding member 40 allows skewer 10 to be mounted on skewer holder 1 without skewer 10 falling through aperture 8. In some embodiments, skewer holder 1 comprises aperture recesses adapted to fit the shape of holding member 40. In one embodiment, holding member 40 comprises a ring-shaped protrusion and skewer holder 1 comprises ring-shaped recess adapted to fit the protrusion at the top edge 8A of aperture 8.

Another aspect of the invention provides apparatuses for coating food items comprising the skewers as described herein, a skewer holder, including the skewer holders as described herein, and coating material, such as dark chocolate, white chocolate, milk chocolate, powdered sugar, and/or the like. In one embodiment, food items 6 are secured on skewers 10. Skewers 10 are then inserted into apertures 8 in skewer holder 1, which may contain a plurality of apertures 8. Apertures 8 in skewer holder 10 are dimensioned to removably engage skewers 10. Skewer holder 1 may be turned upside down to expose food items 6 secured on skewers 10 to coating material, which may be in a vat, tub, tank, container, and/or the like. Engagement portion 20 in expanded configuration 32 prevents skewers 10 from falling out of skewer holder 1 through apertures 8. In some embodiments, skewer holder 1 is placed over a vat of coating material and lowered to expose food items 6 to such coating material in the vat.

Another aspect of the invention provides methods for coating food items. In one embodiment, the method comprises a first step of securing food items 6 on skewers 10. Securing members 42 of skewers 10 may be used to prevent food items 6 from being inserted too far into skewers 10. Each skewer 10 with secured food items 6 are then inserted into an aperture 8 of skewer holder 1. In some embodiments, grip portion 16 is the first portion being inserted. In some embodiments, apertures 8 are smoothbored. In some embodiments, skewers 10 are inserted into skewer holder 1 without food items 6, and food items 6 are secured onto these inserted skewers 10. As a skewer 10 is inserted into an aperture 8, engagement portion 20 contacts the inner surface of aperture 8 at top edge 8A. The contact with inner surface of aperture 8 compresses engagement portion 20 and engagement portion 20 changes from expanded configuration 32 to compressed configuration 34. Engagement portion 20 may be removably retained within aperture 8 in compressed configuration 34. Skewer holder 1 is then turned upside down and lowered into coating materials, such as chocolate, powdered sugar, and/or the like, to coat food items 6. After coating is performed, skewer holder 1 is lifted up to remove food items 6 from the coating material. Skewer holder 1 is then turned right side up. In some embodiments, the methods are repeated for different coating materials to achieve layered coatings on food items 6. Skewers 10 with coated food items 6 may then be removed from skewer holder 1. In some embodiments, food items 6 are removed without removing skewers 10. In some embodiments, skewers 10 are inserted such that engagement portion 20 passes through bottom edge 8B of aperture 8 and engagement portion 20 changes from compressed configuration 34 to expanded configuration 32 upon release from contact with inner surface of aperture 8.

In some embodiments, the method comprises the use of skewers 10 having engagement portions that comprise bridge members 22 and compression apertures 24. In these embodiments, upon insertion of a skewer 10 and its engagement portion 20 into aperture 8, bridge member 22 moves into compression aperture 24 after contact with the inner surface of aperture 8, and engagement portion changes from expanded configuration 32 to compressed configuration 34.

As will be apparent to those skilled in the art in the light of the foregoing disclosure, many alterations and modifications are possible in the practice of this invention without departing from the spirit or scope thereof. For example:
Compression aperture 24 may comprise of other shapes and need not be rectangular in shape.
Aperture 8 may be triangular, rectangular, square, and/or the like.
Food items 6 may be fruits, such as pineapple, melon (including water melon, honeydew, sugar melon, and/or the like), strawberry, banana, apple, orange, kiwi fruit, cherry, grape, cantaloupe, and the like.
Apertures 8 may have flanged portions for frictional engagement with skewers 10.
Multiple skewers 10 may be inserted into a single aperture 8.
Food items 6 may be dipped into different coating materials consecutively to form layered coatings on food items 6.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

Accordingly, the scope of the invention is to be construed in accordance with the substance defined by the following claims.

What is claimed is:

1. A skewer for securing a food item and insertion into an aperture of a skewer holder, the skewer comprising:
a retention portion at one end of the skewer configured to receive and secure the food item;
a grip portion at an opposite end of the skewer; and
an engagement portion between the retention portion and the grip portion, the engagement portion having a compressed configuration when in contact with an inner surface of the aperture in which a longest engagement portion cross-sectional width is less than a shortest aperture cross-sectional width and an expanded configuration when not in contact with the inner surface in which the longest engagement portion cross-sectional width is greater than the shortest aperture cross-sectional width.

2. A skewer according to claim 1 wherein the engagement portion comprises a compression aperture and a bridge member connecting the retention portion and the grip portion around the compression aperture.

3. A skewer according to claim 2 wherein the bridge member moves into the compression aperture upon contact with the inner surface.

4. A skewer according to claim 2 wherein the bridge member extends away from a side of the skewer at an angle at or greater than 90°.

5. A skewer according to claim 2 comprising two or more compression apertures and two or more bridge members.

6. A skewer according to claim 5 wherein the two or more compression apertures and two or more bridge members are arranged symmetrically about a longitudinal axis of the skewer.

7. A skewer according to claim 2 wherein the bridge member is integral to the structure of the skewer.

8. A skewer according to claim 2 wherein the bridge member is connected to the skewer around a cavity to form the compression aperture.

9. A skewer according to claim 1 wherein engagement portion comprises an engagement member and a cavity shaped to fit the engagement member, the engagement member moving into the cavity upon contact with the inner surface.

10. A skewer according to claim 1 wherein the engagement portion comprises a compressible member.

11. A skewer according to claim 10 wherein the compressible member is comprised of foam.

12. A skewer according to claim 1 comprising a holding member that is biased against a surface of the skewer holder after the insertion.

13. A skewer according to claim 12 wherein the holding member comprises a ring-shaped protrusion.

14. A skewer according to claim 1 wherein the retention portion terminates in a beveled tip.

15. A skewer according to claim 1 wherein the skewer is symmetrical about its longitudinal axis.

16. A system for coating fruits comprising the skewer of claim 1 and the skewer holder comprising the aperture, the engagement portion dimensioned to removably engage the aperture and to change into the compressed configuration when the engagement portion engages with the inner surface.
